(19) United States
(12) Patent Application Publication
(10) Pub. No.: US 2006/0005126 A1
(43) Pub. Date: Jan. 5, 2006

(54) Method for manipulation of objects within electronic graphic documents

(76) Inventor: Shaul Shapiro, Tel Aviv (IL)

Correspondence Address: PEARL COHEN ZEDEK, LLP, 10 ROCKEFELLER PLAZA, SUITE 1001, NEW YORK, NY, 10020, US

(21) Appl. No.: 10/530,419

(22) PCT Filed: Oct. 7, 2003
(86) PCT No.: PCT/IL03/00801

§ 371 Date: Apr. 7, 2005

Related U.S. Application Data
(60) Provisional application No. 60/416,255, filed on Oct. 7, 2002.

(51) Int. Cl. G06F 15/00; G06F 17/30

(52) U.S. Cl. 715/522; 715/513; 707/1

(57) ABSTRACT

A method of transforming location based objects, such as text, included in a digital source Artwork file, for example a geographical map file, and creating a transformed target Artwork file. The method is particularly advantageous in converting geographical maps from one language to another. The method includes tools for extracting the required location based objects, for example text elements, from the source file, including all pertaining information, into a first intermediate structured database, represented for the user as, for example, a structured table. The required transformations are then operated on the extracted objects, partly manually but also automatically creating a transformed second intermediate database, which is subsequently integrated with the source file to create a target file, which represents, for example, a new map with translated text on new layers.

### FIELD AND BACKGROUND OF THE INVENTION

The present invention is related to a document processing method and corresponding system, and especially to the method and system used to automatically manipulate objects contained within existing electronic artwork documents. Modern electronic document processing for publishing, either for print or digital display, frequently requires design and production of visually rich content. There are many software packages available for professional creation, layout and editing of drawings, illustrations and images, together with text, henceforth such hybrid documents will be generally referred to, as known in the art, as Artwork. Following is a concise list of known in the art professional Artwork producing programs:
Graphic Draw (Illustration, Vector) programs: Illustrator™ by Adobe Systems Inc.®, USA.; Freehand by Macromedia Inc.®, USA.; Corel Draw™ by Corel Corporation®, Canada.
These programs are typically used for creating complex and graphically rich documents for print and display.
Page layout programs: Quark Express™ by Quark Inc.®, USA., Pagemaker™ by Adobe Systems Inc.®, USA., InDesign™ by Adobe Systems Inc.®, USA.

These are popular desktop programs, typically used for design, layout, editing and manipulating of multi-page documents involving larger amounts of text together with and around graphics, drawings, illustrations and images.
Image editing (paint) programs: Photoshop™ from Adobe Systems Inc.®. PhotoPaint™ from Corel Corporations, Canada.
These programs are typically used for creation, editing and manipulating of photographic (Bitmap) images, and also have some text handling capabilities.

All the above mentioned program families are commonly referred to as DTP (Desk Top Publishing) applications. These modern DTP applications typically rely for their output on the core graphic functionalities of the Postscripts Page description Language (PDL) by Adobe Systems Inc.®.

Computer Aided Design (CAD) programs such as AutoCad™ by Autodesk® Inc. are typically used for design, production and editing of technical and engineering drawings. CAD programs typically rely on different PDLs.

Additionally, for each of the above-mentioned programs plug-ins and extension program from other vendors exist that add functionalities onto the basic application. For example, MapPublisher™, by Avenza®, Canada, that facilitates the creation of geographic maps using external data from Geographic Information System (GIS) databases. MapPublisher™ is offered for both Illustrator by Adobe Systems Inc.®, USA and Freehand™ by Macromedia Inc.®, USA.

A distinction should be drawn between Artwork creating programs and word-processing, spreadsheet, database and other, typically office oriented applications, which may also have some limited Artwork creation functionalities, but are primarily designed for different uses.

Typically, artwork programs handle text objects and graphic non-text objects in the same manner, offering many common manipulation and transformation tools.

In this document an Artwork creating software program will be referred to as Artwork program, and a file created by an Artwork program will be referred to as an Artwork file.

Typically an Artwork may contain text in relatively short descriptive phrases, such as titles, slogans, labels, annotations, headers, captions, inscriptions, etc., as well as longer paragraphs, henceforth to be referred to as Text Objects. Artwork programs are generally employed for various fields of applications such as drafting of machinery parts (CAD), map making, advertising and other printed material, as well as for electronically distributed files. Some Artwork programs, namely Illustration (Draw) and Computer Aided Design (CAD) programs, are especially designed to create complex graphics, such as maps that may also contain numerous short text labels as well as other basic graphic objects, such as lines, circles, ellipses, squares, rectangles and more complex objects created from the basic objects or part of them.

The present invention deals with capabilities, limitations and deficiencies of currently available Artwork programs when the pupose is to externally apply changes in an efficient way, whether these changes are, location attributes and/or style attributes of textual and non-textual objects to one or more objects in an Artwork, as well as to externally add new objects to an existing Artwork file as a result of calculations or transformations externally applied to the original objects.

A brief description of the common modification handling capabilities of known-in-the-art programs is hereby presented. All Artwork programs offer tools for entering, importing and editing of text and graphic objects, typically allowing precise graphic manipulations and modifications of Graphic Attributes such as position, distribution, direction and relations to other objects. Furthermore, these Artwork programs provide tools to access and precisely manipulate various features pertaining to text formatting Character Attributes such as typeface, font size, weight, alignment, etc., and Paragraph Attributes such as width, height, justification, line spacing, etc. . . . Illustration programs further provide tools for applying special effects to objects and text, such as attaching text to path, wrap text around graphics, scale, mirror, reflect, add outline, inline, zoom and highlighting effects. Henceforth the combined text and object formatting and transformation features will be referred to as object manipulations.

Modern structured documents may be produced, using layer and style metaphors, allowing names to be applied to layers and to sets of appearance attributes called styles.

Artwork programs are typically operated by skilled professionals such as graphic designers, draftsmen, cartographers and DTP computer operators, trained in using these sophisticated software tools. Henceforth the typical operator of an Artwork program will be referred to as Designer.

An Artwork can be a relatively simple task of creating a measuring ruler or a complex task such as a road map, a packaging design, a drawing of a machine part, an advertisement or illustration to be subsequently printed as a map, a poster in a magazine or newspaper, etc., which alternatively may become part of a web page or a multi-media presentation. A typical geographic map for a school atlas will be provided henceforth as an Artwork example and will be related to throughout this document.

The preparation of a single page of Artwork involves several stages and requires performance of many steps and operations. The Designer's job typically originates from other professionals, such as teachers, engineers, scientists, art directors, editors and other professionals from vastly diverse fields. We shall use the general term Originator henceforth in this document. An originator would typically specify the required artwork and provide the information needed by the designer to perform the production of the artwork.

In a typical production workflow several stages of planning, designing, editing, revising and correcting are required. A designer, working with an Artwork program is required to provide intermediate proofs both for review and comment by the originator, proofreaders or experts in the relevant area. Examining a typical workflow nowadays will likely reveal that, due to differences in computer programs and platforms, the designer's output (Artwork) is seldom sent out as a “Working file” (in the native Artwork program file format), but is printed out as a “hard copy” or delivered as digital files, typically Adobe Acrobat (PDF) files which are universally viewable, notatable and printable. Since the originator, designer, editor, proof reader etc., seldom work together at the same physical place, printed proofs and/or PDF files need to be distributed or passed along from one professional to the next, and their various recommendations need to be indicated and sent back to the designer. Typically, required modifications to the Artwork have to be manually performed by the designer within the specific Artwork program.

The typical production process, involving several steps, operations and interactions between several professionals for a typical job such as the creation of a map for a school atlas, i.e. a single page of Artwork, may take several days or weeks until approved and considered final.

Once completed, the textual content of the Artwork may have to be translated into other languages. The objective of translating an Artwork will be dealt with in detail in the present invention.

The original language of the text in the source Artwork will be henceforth referred to as the “source language”.

The new desired language will henceforth be referred to as the “target language”.

A copy of the Artwork file in its original file format in the source language, will typically be available as well as a printed “hard copy” and/or a PDF file for the preparation of the required translations into the target language. To this end the text elements in the Artwork must be located and marked for translation and preferably be extracted to a text file.

Typically an Artwork program provides an option to “export” a file with the text strings only (.txt) or with some limited formatting (.rtf) file. No information concerning layers or styles, nor attributes such as Graphic, Effect and Transformation Attributes are typically included in such files.

A text file is the most common file format allowing translators to work on their preferred computer platform, using their own programs, typically word processing applications, to provide their translations. Within the word-processing program, translations are typed or imported (“copy and paste” operation) next to or following the original text elements. Translators may make use of “Translation Memory” programs that offer tools for the recycling of existing translations.

Since the average translator is not skilled in the use of Artwork programs, the target language translations are typically provided to the designer in the translator's word-processing program file format, as an RTF file, as a plain text file or as a “hard copy” printout. For ease of use, the source language text together with the target language may be provided in a tabular format. The designer has to “open” the relevant source Artwork file in its originating Artwork program and replace each text element with its corresponding target language translation. Presently, the designer has to manually perform this task of replacing each desired text element: each text element must initially be identified, located and selected, and then retyped in the target language or “pasted” by a “copy and paste” operation. To provide the target language text elements for the “copy and paste” operation, the translator's file must be opened, each target language text element identified, located, selected and “copied” manually into the computer's memory “clipboard”. A typical “find and replace” operation may also be employed, involving substantially the same operations, gaining efficiency mainly when an Artwork is heavily cluttered with text objects. For the translation of a typical Artwork, such as a road map this same procedure may need to be repeated numerous times.

Working with several languages may require loading additional operating system support for the relevant language. Typing a translation in another language, especially for non-Latin scripts such as Cyrillic, Hebrew or Arabic will usually involve loading the appropriate keyboard layout file (in MS Windows—through the Control Panel, International) and may also require replacing the actual hardware keyboard attached to the computer, as this keyboard usually corresponds to the primary language of the user.

Target language text may also require change of fonts, appropriate fonts may have to be selected, obtained and installed in the designer's computer. Additional operations may also be required from the Designer such as specifying, creating and naming new styles and layers. Text in one language is rarely similar to the same text in another language as to the number of characters or words. Designer intervention may further be required in order to manipulate target language text alignment, placement and attributes, such as character size and weight, kerning etc.

A Designer may not be proficient in the target language. Thus, incorrect replacements and spelling mistakes (“typos”) are likely to happen and careful proofreading is required. When corrections are indicated, the designer has to re-open the relevant Artwork, identify each faulty text and manually replace or correct it. For translation of Artwork into foreign scripts a Designer with the specific language skills may have to be enlisted or the Artwork file may need to be passed on to another Designer, possibly in another country.

Adding objects such as translations onto an existing Artwork also presents more problems. It may be necessary to add an object onto an existing artwork in a location relative to another existing object. Such additions may be required when an additional text object in another language, such as a translation, transliteration or alternative name, has to be inserted to appear next to a source text object. Typically the added text may be required in a different font, possibly with different attributes such as size or color. In such a case, when the source text object is not erased or replaced, the Designer has to manually identify and locate both the relevant source and the target text objects, and then manually place, align and apply the relevant attributes for each additional text object. Precise positioning and alignment of the additional text object in an exact relative position to an existing text object is typically required.

An artwork file may be manually created by a Designer, or may be derived from computerized information contained in other sources, such as Geographic Information System (GIS) data as is frequently the case when creating modern maps and atlases.

Positioning of objects in an Artwork and/or placing the objects on a page is a task that involves skill, artistic approach and additionally an inspecting eye. A file that is automatically generated is in many cases unacceptable by common standards. A lot of manual work is needed in order to adapt a GIS map to a form that can be acceptable according to the cartographic tradition. Required manual work typically involves placement of objects, direction of texts, local displacement of labels, as well as changes in text formatting—increasing and decreasing type size, changing the justification of compound names which run multiple lines. Much academic work has been done as well as specialized software developed by commercial companies, such as ESRI, producers of Maplex™, a map labeling software (http://www.esri.com/software/maplexlo, to automate such tasks as, for example, collision detection, placement of captions according to the geometry of the area these captions refer to. Even with such programs, a Designer typically needs to work long hours in order to modify a computer generated artwork file, so that it will be considered acceptable by artistic standards. Related patents and products are beyond the scope of this invention, as the objective rules for relocating objects can only serve as an approximation in the attempt to create a clear and visually pleasing artwork file, as described earlier.

A Designer, may have to create actual inaccuracies (relative to the actual locations) in the resulting map, because more than one element may have to be placed in each others proximity. In order to avoid collisions and clashes the Designer may move or separate the objects so that at least one of them is not in its exact geographic location, The decision which element should be moved, in which direction and what other changes to objects have to be performed has not yet been automated. Some programs and software packages (such as Maplex™ by ESRI) offer a limited solution to these problems by assigning elements an “importance value” that is used to determine which element has precedence over the other when changes are to be applied. Maplex™ also enables the Designer to decide what will be the order of label positioning of an object relative to its actual location. None of the related patents or programs the problem of actual changes in the location of the representing point, which defines the location of an object. These programs merely deal with the positioning of the label, assuming the point is in a fixed location.

It is therefore clear that even when a very sophisticated package has been used to better position objects and labels on a page, a map etc., additional manual work, which cannot be saved and reproduced automatically on new versions of the artwork file, if they were to be recreated from updated GIS data.

From the previous discussion it is clear that in reality, the automatic process of converting large corpora of data into an artwork file that can be viewed, displayed or printed needs manual human intervention in order to achieve useful as well as visually pleasing results. When applying major changes to an existing artwork file it is often a dilemma whether to recreate the file afresh from the raw data, and incure the added cost of incorporating all the manual changes into it, or to manually apply relevant changes to the Artwork's previously edited file. It is therefore clear that when a global change to labels is made, such as translating from one language to another, one cannot simply create the map afresh from the original G.I.S. data because the information relating to all objects that were displaced from their original location, was lost.

Therefore, when changing the language of the Artwork file, for example when creating a new version of a map in another language, it may be advantageous not to start “from scratch” from the original data and replace the text into the other target language via the GIS database, but from the then-final version of the Artwork file and introduce whatever language specific changes are necessary in that file. Recreating the map and introducing the same displacements, relocations and typographical changes to the elements in the map is very costly and inefficient. It is frequently more economical and therefore advisable to start with the artwork file, which already contains the necessary changes due to overlaps, collisions and like considerations, together with culture-driven changes, and to change that file according to the new requirements—be it translation into another language, a newer version, the correction of certain parameters and changes in some objects.

Related Prior Art to the invention to be described hereinafter includes various software programs that offer extraction of text from existing text document files such as word processing, etc. for purposes such as construction of terminology lists, indexing, aligning for translation, etc. Other programs typically parse existing software resource files extracting text for translation of the user interface and messages needed for construction of localized or multi-lingual computer software and operating systems (Particularly important for this discussion are Translation Memory (TM) or Machine Assisted Human Translation (MAHT) and Terminology Management Tools). Some of these software tools allow the translator to improve his productivity and consistency by re-using terms and sentences they have translated in the past by using TM. Still other software utilities exist foe translating labels in CAD files/

The following U.S. patents may be regarded as prior art: U.S. Pat. Nos. 6,345,244; 5,678,039; 5,678,039; 5,497,319; 5,850,561; 5,551,055. none of these patents teach a method close to the one described herein. These patents merely describe ways of extracting text from either scanned, bitmap files and reconstructing a new graphic based on transformed texts, or merely pertain to the task of translation matching, which is not the scope of this patent.

There is at least one product, “Annotationtranslator” for AutoCAD files by CR/LF GmbH from Germany which is a simple translation tool to produce the same CAD drawing in more than one language. This tool only gives access to the text of an object, without allowing control over other parameters such as the layers, text style, position manipulations, etc.

The popular Adobe Acrobat Portable Document Format (PDF) may be defined as an Artwork file. Several commercial software programs, such as JADE by BCLTechnologies and Gemini by Iceni, are offering extraction of text from within Adobe Acrobat PDF files, with some of its formatting. These programs allow only “one way” extraction, typically for further manipulation in other programs. An automatic method for replacing text objects is offered by Adobe Systems Inc.®. This method, named “Data-Driven Graphics” may be performed from within Adobe Illustrator™ Artwork program. This method involves manually placing variables to be embedded (bound) into objects. The textual content may be automatically accessed and manipulated through the identification of these embedded variables. Access to previously embedded code is also offered by Adobe Systems® in their Graphics Server™ functionalities.

Limitations of Prior Art Methods:

The automatic methods offered by Adobe Systems® are incapable of processing the vast numbers of existing Artwork digital files. These methods involve manual insertion of variables, so any desired manipulation to the text objects requires extensive manual handling of each text object. No automatic method is offered for extraction of text objects. No external interface for manipulating properties is offered.

All other (none Adobe) prior-art methods may now be further discussed and criticized. The typical text handling capabilities provided by the prior-art programs or documents are limited to basic formatting properties only, such as typeface, size, weight, justification, tabs, etc.

For clarity, a fundamental distinction should be drawn between simple text, which may carry some limited formatting properties, and Text Object Attributes having a wide set of properties pertaining to the appearance of the text object (as described at the beginning of this document).

The prior-art may provide a method to externally edit content but fails to provide for precise transformations, manipulations and modifications to position and appearance attributes. Prior-art makes no reference to text objects, in the sense used within graphic, Artwork producing applications, where a text is also regarded as a graphic object. Prior-art makes no reference to the layers structure, an extremely important feature of Artwork programs, nor offers a solution to create new layers via external means.

Access to the extremely wide array of precise Text Object Attributes is offered only within Artwork programs, programs typically having strong reliance on the Postscript PDL (Page Description Language) and its underlying Vector (Object Oriented) structure. Artwork programs' fundamental design is based upon a basically static, fixed location of each and every text object, with precise reference to “points” on a page defined by coordinates. In contrast, the position of texts in text editors and word-processing programs is relative to the text preceding it on the page, and may be modified by changes in previous pages. Text editors and word-processing programs are generally concerned with multi-page documents and the flow of “running” text. If a portion of text is removed, the following portion of the document will typically “re-flow”. When a change to the page size or the margins is performed, it will typically influence the formatting and all text may re-flow, forcing movements to all text and other elements.

A fundamental limitation of the above-described prior-art processes is the total separation between the Originator and the “his” Artwork. Another limitation is that the Designer, operating his Artwork program, must manually perform all manipulations to the text objects contained in an Artwork. When external database interactivity is desired for text object manipulation or replacement (such as by Adobe), each and every text object must be manually provided with special information or code, from within the Artwork program.

The above described processes are laborious, tedious, time consuming and prone to error, and therefore very costly. There is no currently available method and system to accomplish all above mentioned object manipulations in an automatic, cost efficient manner.

### OBJECT AND BRIEF SUMMARY OF THE PRESENT INVENTION

The object of the invention is to provide an integrated expert system for efficiently transforming location based objects, such as text or graphic objects, included in a digital source Artwork file, for example a geographical map file or a CAD design, and creating a transformed target Artwork file. The method is particularly advantageous in converting geographical maps from one language to another, avoiding major re-editing of the source file, but keeping the appearance and quality of the location based translated text. The method includes tools for extracting required location based objects, for example text elements, from the source file, including all pertaining information into a first intermediate structured database, represented for the user as, for example, a table. The required transformations are then operated on the objects stored in the table, partly manually but also automatically creating a transformed second intermediate database, which is subsequently integrated with the source file to create a target file, which represents, for example, a new map with translated text objects on new layers.

The method includes user visible and operable intermediate structured files, preferably tables, which enable constant quality control of the operation and external manual intervention in the location and appearance attributes, where required. A knowledge base repository is included, permitting accumulation and subsequent use of information relevant to the operation, such as translation of geographical text elements from one language to another.

The invention is implemented in software, based on known in the art Artwork design and data manipulation tools with the necessary additional software elements permitting the user, may it be the Originator or a Designer, to work in a familiar environment.

### BREIF DESCRIPTION OF THE DRAWINGS

The invention is herein described, by way of example only, with reference to the accompanying drawings, wherein:

FIG. 1 illustrates a schematic flow chart of the embodiments described in the present invention.

FIG. 2 illustrates an exemplary Source Project Database, as described in the present invention.

FIG. 3 illustrates an exemplary Type Aspect Table, as described in the present invention.

FIG. 4 illustrates an exemplary table representing part of the Intermediate Project DB, as described in the present invention.

FIG. 5 illustrates an exemplary representation of the automatic extraction process of text objects from a Source Artwork to the Source Project Database, as described in the present invention.

FIG. 6 illustrates an exemplary representation of the automatic integration of text objects from the Target Project Database to the Target Artwork, as described in the present invention.

FIG. 7A and FIG. 7B illustrates an exemplary process of creating a graphic object with minimal text, as described in the present invention.

FIG. 8 illustrates an exemplary table representing the Source Project Database, as used for creating a graphic object of FIGS. 7A and 7B.

### DESCRIPTION OF PREFERRED EMBODIMENTS

The present invention discloses, by way of example, three preferred embodiments, each employing different means for achieving the same end.

A third embodiment describes how this invention is employed to perform creation of new Artwork by pre-preparing the objects in a suitable manner.

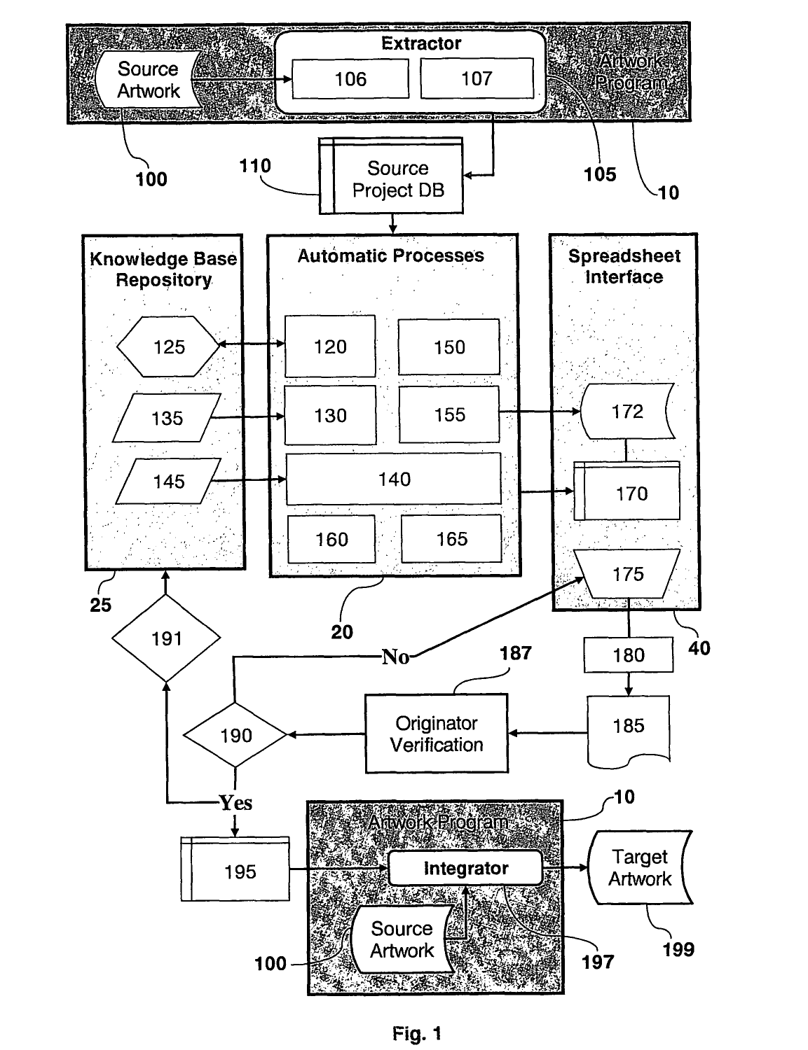

In the first embodiment, the extraction of selected objects is performed from within Artwork Program 10 of FIG. 1, for example Freehand™ by Macromedia Inc.®, USA., at run-time, through the use of specifically developed plug-in software to be described herein. A schematic flow chart of this embodiment is provided, marked as FIG. 1. The plug-in software module, labeled “Extractor”, is marked as task 105. The “Extractor” 105 extends the capabilities of the Artwork Program original functionalities, offering several options for automatic extraction of the desired objects, together with all pertaining information, into a suitably pre-constructed database.

The Source Artwork file 100 is loaded into the Artwork Program 10 and the user selects the objects of interest (based on the layers in which they are defined, their style, or other properties). The “Extractor” 105 scans 106 the Source Artwork file 100 and extracts each selected object, using known in the art tools, with its corresponding object attributes, together with other desired information and populates a database table, marked as Source Project DB 110. This table marked Source Project Database 110 is pre-constructed in such a way, that each Source Artwork object is defined as a record (row), and stored with any desired information related to it, such as its layer name, object attributes, style, position, alignment, orientation, location, color, etc., each arranged in their respective database fields (columns). Exact location coordinates defining bounding box of the object, its shape, angle, orientation, direction and any other desirable information are included.

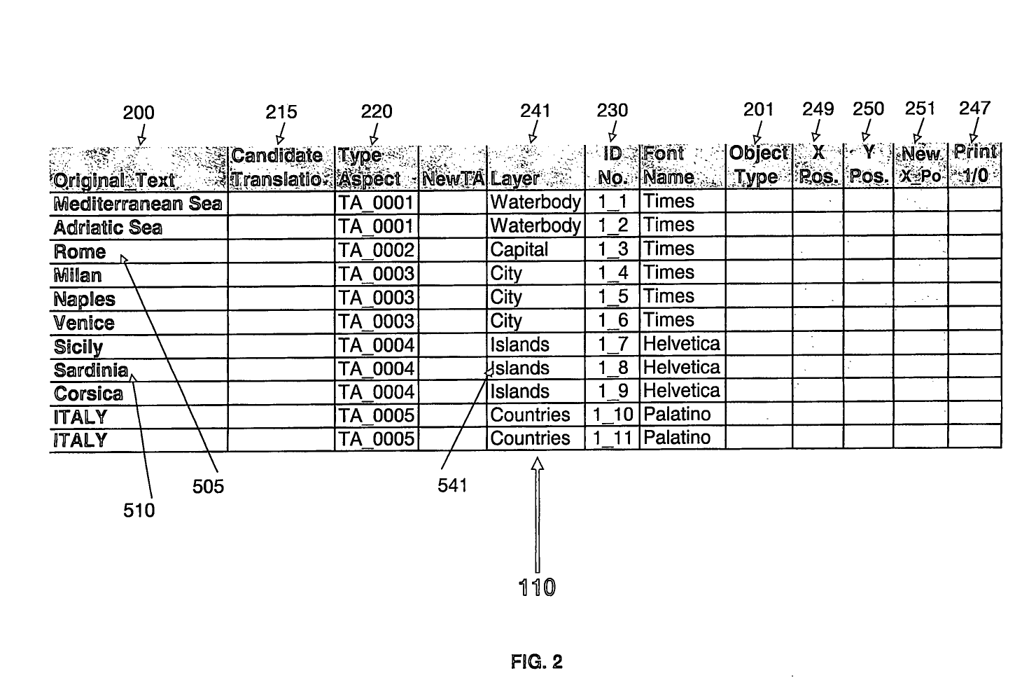

For each object the Extractor records the internal object's ID number, and if such ID number is not found—assigns 107 a sequential ID Number to all selected objects in the Source file, and registers this ID Number alongside the object's properties in the database file (column 230 in FIG. 2). The Extractor assigns this ID number to the object itself in the Source file, by using commands and software tools usually present in the Artwork Program or supplied by its vendor. In cases where the original Artwork Program does not support adding an identification field to objects, the Extractor adds an attribute whose value corresponds to the sequential identification number and which does not cause a change to the appearance of the object in the Artwork file. It was found that such inert attributes can be found with such Programs if an identification field is not available. Alternatively, this ID Number can be put as an object on a new, dedicated layer, in a position relative to the location of the object to which it refers. Additionally, an option may provide that the ID Numbers be displayed affixed to the objects' text, so that it appears as a prefix or suffix of the object in any visible representation. A sample representation (partial “screen grab”) of such database 110 is provided and marked as FIG. 2.

A number of automatic processes operate on a working copy of the Project DB 110 according to rules and lists of changes stored outside the programs. These processes use a Knowledge Base Repository 25 where rules for creating objects, assigning attributes and Type Aspects to them are stored and maintained. A Multi-lingual Master Database 125 is provided within the Knowledge Base Repository 25 for storage, management and control of the acquired textual data from many related Project Databases. This Master Database may be automatically expanded with translations and relevant other related data accumulated from previous related projects and evolves with each use. The rules in the Knowledge Base Repository are updated and changed according to the experience acquired through applying the rules to projects, so this is a dynamically updated database.

The Master Database 125 may be a Relational Database. It may be provided with tools to connect to other, external or remote databases, dictionaries and glossaries, to search and obtain required data. It can also be a commercial Translation Memory as is known in the art.

In the group of Automatic Processes 20, an automatic task 120 scans the list of original text 200 (FIG. 2) and tries to find a match in a multilingual translation DB 125. If previous translations are found, they are retrieved and placed in a “Candidate translations” field 215 (FIG. 2) in the working copy of Source Project Database 110. If previous translations are not found, the corresponding field is left blank. The simplest way to retrieve previously approved translations is by extracting the column containing the names and words that need translation 200, translating them using the tools and methods provided by known in the art Translation Memory programs to receive a translated column of words, and then reinstalling the translated text column in the “candidate translation” column 215.

Another automatic task 155 in group 20 analyzes the records and automatically assigns an alphanumeric Type Aspect (TA) or Style Name to each record in the working copy of database 110. Objects that share a predefined set of attributes, such as the same typeface, font size, weight etc., as well as the same layer are assigned a similar TA. This TA is disjoint from the object's style, as assigned in the Artwork Program, and it is artificially created by the Extractor based on similarity of objects sharing common properties. Thus objects that are assigned different styles in the Artwork Program may be assigned the same alphanumeric TA name by the Extractor, in cases where the different Artwork style names have in reality, the same attributes.

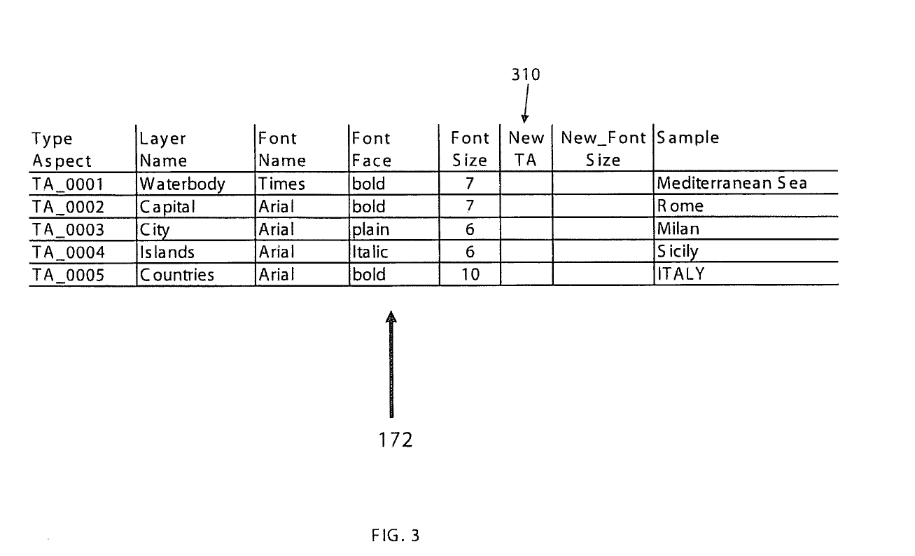

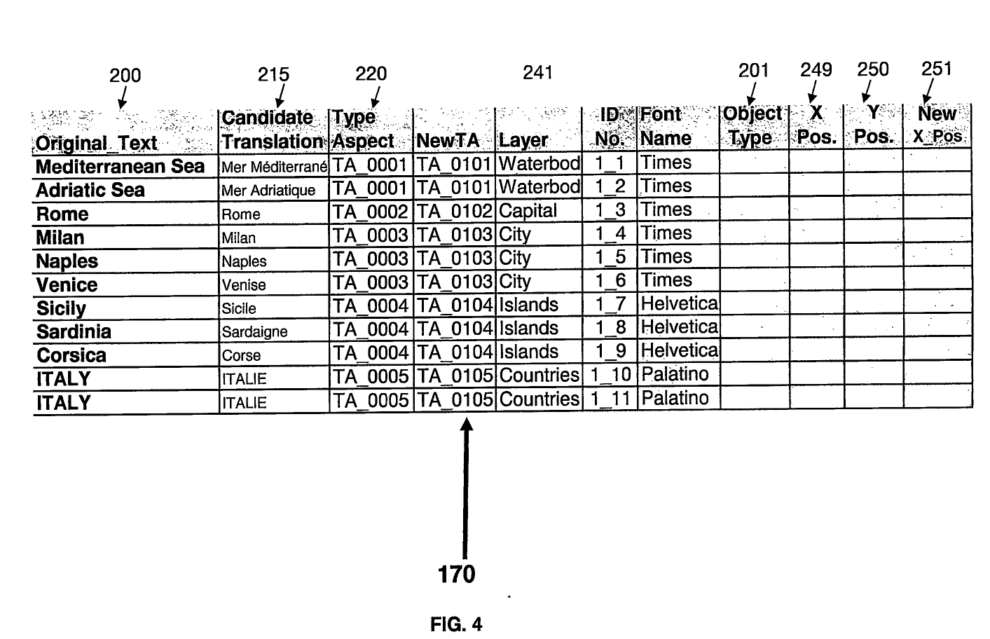

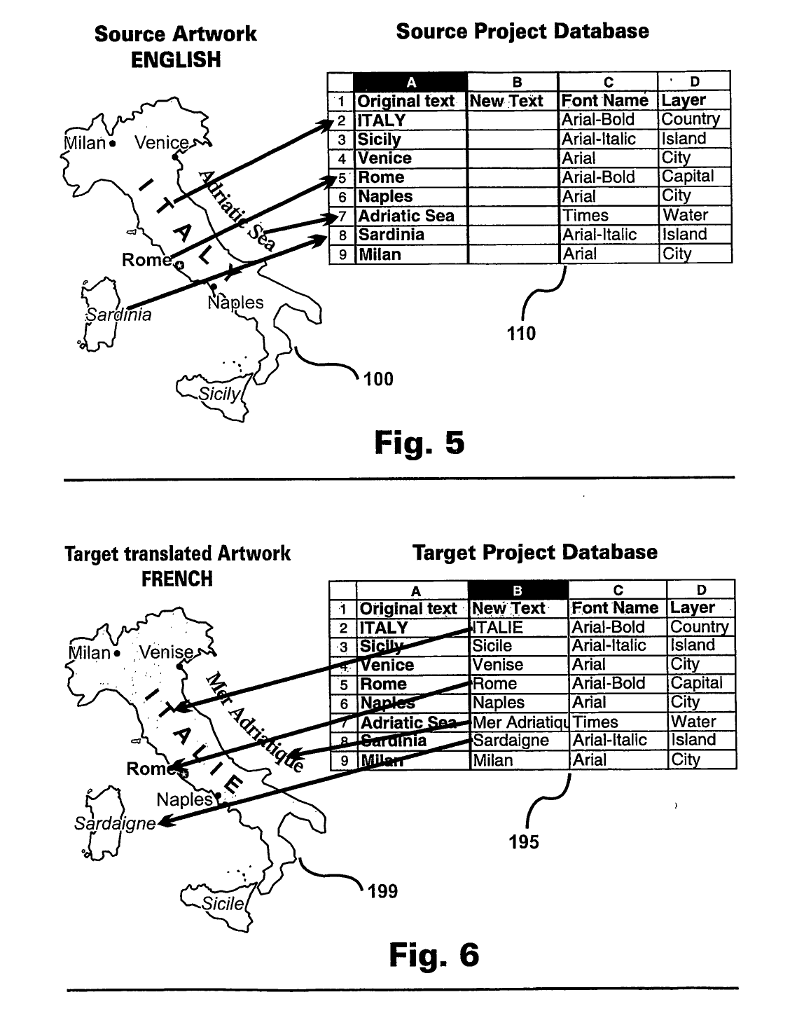

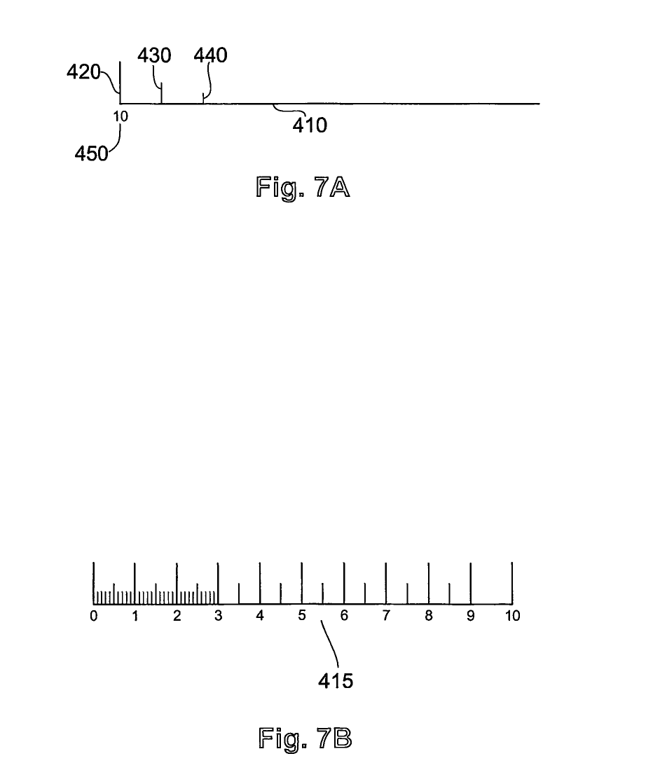

Another table 172, part of the group of Spreadsheet InterFace 40, is automatically created, listing all the different newly created Type Aspect Names together with their defining attributes. A sample of a Type Aspect Table is shown in FIG. 3. Representation Rules 135 (group 25) are used to automatically change the Type Aspects and intrinsic attributes of objects due to different language, aesthetic constraints that require size change etc. i.e. when translating from one language to another, the size of print (point size) may need to decrease, or increase, to preserve the same legibility of the original text. Such point size changes may require further changes such as leading, inter-letter space etc. This task is marked 130 in group 20.

New objects are introduced into the working copy of Project DB 110 by automatic process 140 that uses creation rules 145 in group 25 to introduce new objects into the DB. Such automatic object creation and insertion may, for example, add rectangles in a special color, as background objects for highlighting questionable text objects that need user attention, connecting questionable objects with visible lines, and adding objects according to a general rule—such as adding an underline to a specific group of objects based on their attributes. The user can add objects manually, by editing the table accordingly. This is done by inserting new rows (either newly created or duplicating existing rows and changing their contents) that represent the new objects and their attributes.

A specially prepared software program Spreadsheet Interface 40 is provided to ease the interaction of laymen such as originators to the database, by transforming the Source Project DB 110 into an interfacing format 170 (Intermediate project DB), which is preferably a spreadsheet. This Spreadsheet Interface 40 also initiates the conversions 160 of character sets for different languages, and other localization issues and data representation issues, such as conversions of local code versions into 16-bit UNICODE character set. Character conversion usually takes place when selecting a different font (and sometimes point-size) than the original ones that were used in the Source file. Finally the working copy of Source Project DB 110 is converted into an easily interchanged format, such as a spreadsheet, by task 165, resulting in the intermediate project DB 170 to which The Type Aspect Table 172 is attached.

Conversions may be performed into desired tabular, textual (with formatting such as tab delimiters or otherwise), word processing, database or spreadsheet format.

It is emphasized that the format of 170 Intermediate DB can be any know in the art format that is easily accessible by the Originator, such as word processing table, spreadsheet or a personal database program. The preferred embodiment uses a known in the art spreadsheet file that is commonly used and enables sorting, enumeration and calculations for maintaining data integrity and other checks.

In the preferred embodiment, an Excel table (FIG. 2) is provided to the Originator or translator, who verifies candidate translations (215) and inserts missing translations into the relevant cells. The intermediate DB 170 may be sent out to several parties for review and editing. In addition to the automatic text substitution through various software products, one can change the text manually, i.e. when the automatic text substitution is found lacking or inaccurate or no match was found. This is done by entering different values in the table in FIG. 2 marked as “manual process” task 175 in FIG. 1.

The quality and accuracy of the translation process is enhanced by the fact that Original Layer Names are provided for each text object in the table of FIG. 2, so that the meaning or general classification of the term becomes readily apparent. This provides for an efficient, fast, less error prone process.

For example, if the translator is not familiar with the name Sardinia (item 510 in FIG. 2), it is a helpful “hint” to be able to ascertain that it is indeed, an Island, as indicated in the “Original layer” field 241 of the table in cell 541.

Additionally the user may define New Type Aspects (FIG. 3, item 310), so that all objects sharing a specific Type Aspect will be shown in a new manner. The rules may include considerations other than the objects' own textual properties, such as, for example, to change the font size of objects in the vicinity of another object or in a specific location on the page.

The Originator may further indicate, in a field provided in FIG. 2, that any new target text object is assigned to a new layer, leaving all original Source text objects intact in their original layers. New layers are automatically created and named with the original layer's name with a predetermined prefix, such as NEW. New layers are automatically marked to become “Visible layers”, while the “old” layers are marked to become “Invisible” layers. (Reasons are detailed later).

The Originator may decide to delete a specific object, by marking it as “non printing” in the relevant field 247. The Originator may modify and override any default attribute or TA at will.

In the first preferred embodiment, font size for the capital city “Rome” 505, as an example, may be required to be enlarged, or the alignment of a text object may need to be modified, such as “Centered” instead of “Left” aligned. Thus, new target text objects may be created within the original Artwork in separate layers, providing the designer, at a later stage, an option to “turn ON” or “turn OFF” the visibility and printability of selected layers for visual interactive inspection and modification. The Originator may decide to add new text objects and specify their attributes. These new, added objects would appear on the Target Artwork, outside of the boundaries of the original Artwork, if the exact location is not specified by the originator. The designer, within his Artwork Program would provide exact positioning of each new text in an interactive mode, at a later stage. This method provides for the integrity of the new text objects and their attributes. After the abovementioned modifications are performed, a DB interface B 180 produces an intermediate output 185 to facilitate the understanding of the new file. This intermediate output 185 is in a different file format, which is easily understood by the Originator and the designer. Such formats can be, for example, a PDF file, or a hard copy printed version of either the Spreadsheet file or the Artwork file, or both. This intermediate output is preferably produced by first creating a temporary Artwork file from the intermediate DB (by activating the Integrator 197 of group 10 as described below) and then producing the intermediate output from this temporary Artwork file.

At this stage the Originator inspects 187 the intermediate output file 185 and if (task 190) corrections or changes are needed, marks it and manually changes it in task 175. If the intermediate file 185 in approved, the Intermediate DB 170 is transformed back into a DB format named Target Project DB 195.

When the Intermediate File is approved, all changes to the file are incorporated in the knowledge base 40. The knowledge base repository 40 is updated either by adding new rules and translation pairs, or by changing the existing ones to reflect the needed changes.

Several intermediate DB's from different projects may be combined into one Target Project DB; Thus the invention provides a method for augmenting existing Artwork, create new Artwork by reusing previous work, and even using previous Artwork as “building blocks” for making new Artwork files without the need to generate such files in an Artwork Program.

Another plug-in software labeled “Integrator” 197 is provided for the Artwork Program 10 for extending the capabilities of the Artwork Program.

Integrator 197 reads the target project DB 195 and creates new layers within the original Source Artwork file 100, in which all the objects described in the Target DB reside. Integrator 197 may delete objects, if so indicated and replace them with new objects in the original layers, to arrive at the desired result Target Artwork file 199. The creation of layers and objects as well as deletion and other operations done within the Artwork Program are performed by using available commands within the Artwork Program.

Using the described methods of the invention, a Source Artwork file with no layers in it may be manipulated and recreated with its original objects laid out in as many new layers as desired. This capability is desirable in many cases where “flat” files are required to be turned into “layered” files. Additionally, manipulation of objects by moving them between existing layers or into newly created layers is also feasible with minimal effort by the Designer.

The disclosed embodiment may be implemented for many different file formats, by pre-conversion into “pdf” (Adobe Acrobat) or “ai” (Adobe Illustrator).

The Adobe Illustrator (“ai”) file format is very popular and supported by many Artwork Programs for data exchange.

### Second Embodiment

In the second embodiment, the Extraction 105 is performed on a “closed” file, in the native program's file format. (Unlike “open” file, within the Artwork Program, at run-time, as in the first embodiment).

In this second embodiment an originating Artwork Program 10 is not required. The Extractor 105 scans the “closed” file, which is the same Source Artwork file 100, and performs substantially the same scanning as in the first embodiment, based on through understanding the file structure.

All steps described above for the first embodiment following the Extraction 105 are performed for this second embodiment by the same tools and methods, with one notable difference, namely:

The Integrator 198 creates a copy of the “closed” file with all the necessary changes are written in the data, producing a new file with the required manipulations, new layers, etc.

The disclosed embodiment may be implemented using the Adobe Illustrator, Acrobat PDF, Autocad DXF, or any other convenient file format, thus providing for its usability for many different Artwork file formats, by pre-conversion into “pdf” (Adobe Acrobat) or “ai” (Adobe Illustrator).

In this embodiment tasks 120 up to 190 are practically the same as described for the first embodiment, and may be using substantially the same software tools.

### Third Embodiment

This embodiment is implemented within the Artwork Program 10, at run-time.

FIGS. (7a), (7b) and 8 will show how the methods of invention are applied to graphic objects without text or with minimal text, such as a measuring ruler. To begin, the Designer defines the required “building blocks” for such a ruler, namely a horizontal line 410 defining the base of the ruler, a vertical line 420 for the major divisions (centimeters in this example), another vertical line 430 for marking the 5 mm divisions, and a short vertical line 440 for the smallest divisions (millimeters). Also defined are the numerals for the ruler 450—as text object with its desired text attributes.

FIG. (8) shows the result of the extraction of this Artwork file into the Source DB. For each column with original property such as x position, y position, length, height etc. there is provided another blank column “new” x position etc. The Designer may duplicate each line corresponding to an object, enter new values for position, length, size, color and any other attribute. This can be done manually or as a result of activating formulae, by copying the formula and hence changing the resulting values according to the position of the line or other methods known in the art. Excel offers internal tools enabling users to create User Interfaces (UI) at will, such UI will ease the creation of the required table.

For other objects such as circles etc. other measurements exist, such as the radius 265 or other dimensions, according to the object at hand.

New instances of the objects are given new ID numbers.

After the integrator 198 reads the file in FIG. (8), the resulting FIG. (7b) shows a ruler as desired, where all the new objects are in the calculated location.

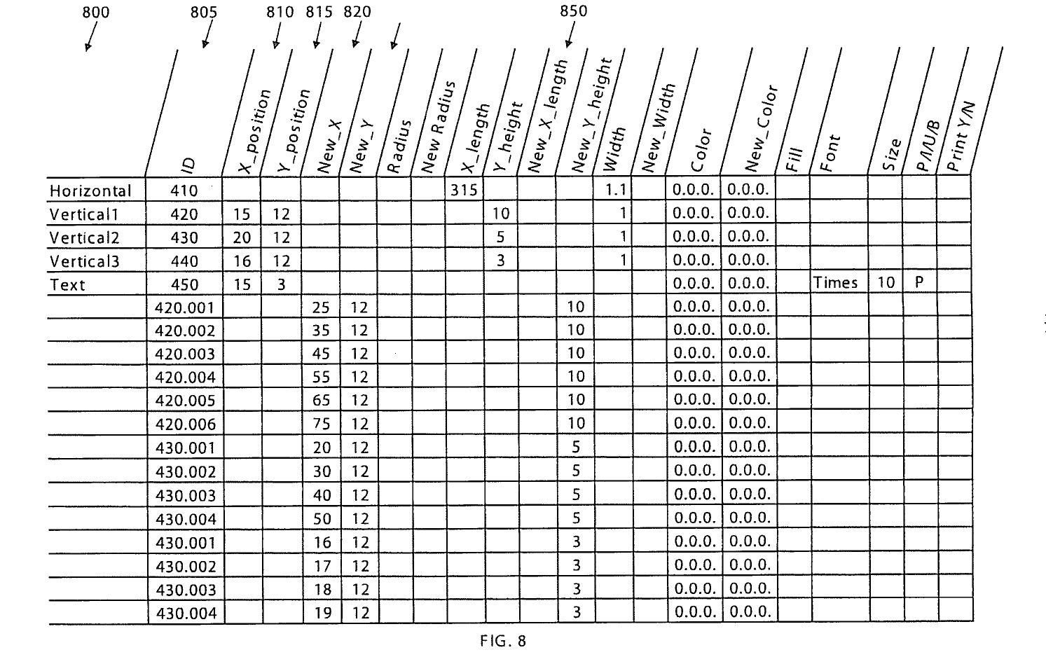

A sample representation (partial “screen grab”) of such a database is represented by FIG. 8.

The advantages of producing an Artwork by the method described in this embodiment lie in the “datacentric” approach, offering flexibility in future recreation of Artwork by simply changing a few parameters in a commonly available tool such as a spreadsheet.

This approach may save many work hours for designers when Artwork is required in several dimensions, such as creating measuring rulers in many lengths and different measuring scales such as Points, Picas, Inches-Decimal and Inches-Imperial.

While the invention has been described with respect to three preferred embodiments, it will be appreciated that this is set forth purely for purposes of example, and that many other variations, modifications and applications of the invention may be made.

1. A method of transforming an Artwork, comprising:
extracting data representing location based objects from a source file of said Artwork;
registering said extracted data in a first structured intermediate database;
transforming said registered data, according to stored instructions;
registering said transformed data in a second intermediate structured database, and
transforming said source file of said Artwork according to said transformed data registered in said second intermediate database to create a target Artwork file.

2. The method according to claim 1, wherein said source files are one of draw-vector graphics programs such as Adobe Illustrator (ai), Adobe Acrobat (pdf), Macromedia Freehand, Corel Draw (cdr).

3. The method according to claim 1, wherein said source files are described in one of Quark Xpress (qxd), Adobe Pagemaker (pm), Adobe Indesign (pdf) or Autodesk AutoCad (dwg;dxf) description file.

4. The method according to claim 1, wherein said source files are described in any page description language that attaches page location to objects described in it.

5. The method according to claim 1, wherein said source files are rich text files described in great detail objects, their attributes and locations, such as in the extended markup language (XML) and its derivatives and related formats.

6. The method according to claim 1, wherein said location based object is expressed in coordinates of a 2D representation medium.

7. The method according to claim 4, wherein said 2D representation is one of geographical map or technical drawing.

8. The method according to claim 1, wherein said location based object is characterized by its appearance, including geometric form, color, line style and print style.

9. The method according to claim 8, wherein said location based object is characterized by identification data including text and numbers.

10. The method according to claim 1, wherein said location based object is characterized by data calculated from its relationship to other objects in the same source file.

11. The method according to claim 1, wherein said first structured intermediate database is represented by a tabular structure, including a spreadsheet.

12. The method according to claim 1, wherein said first structured intermediate database is a tagged text file with sufficient details describing the object so that reconstructing the original file is possible.

13. The method according to claim 11, wherein said first intermediate database is a spreadsheet and the commands for transforming the objects are spreadsheet commands.

14. The method according to claim 13, wherein said spreadsheet manipulation commands are stored in additional related files.

15. The method according to claim 1, wherein transforming includes changing the text associated with an object, or its attributes, or its location on the page.

16. The method according to claim 1, wherein said first intermediate database includes additional data from at least one such database previously prepared from other source files.

17. The method according to claim 1, wherein said first intermediate database includes descriptive data of objects not extracted from said source file.

18. The method according to claim 1, wherein at least one of said objects was given an instruction to be subsequently omitted in said first intermediate database.

19. The method according to claim 1, wherein said transforming includes changing properties of said objects in the source file according to instructions included in said first intermediate database.

20. The method according to claim 1, wherein said transforming includes creating new objects in the source file where second intermediate database includes description of objects not extracted from said source file.

21. The method according to claim 19, wherein for each object detailed in the second intermediate database a new object is created in the source file.

22. The method according to claim 21, wherein said objects are arranged in layers, or not arranged in layers, or rearranged in layers, where new objects are put in new layers or put in the original layers.

23. The method according to claim 1, wherein the data in said first intermediate database can be manually edited by the user including entering new values in lieu of present values in the file.

24. The method according to claim 23, wherein said manual changes can be applied to the original extracted version of said database or a manipulated version.

25. The method according to claim 24, wherein said spreadsheet manipulations can be applied to the original extracted version of said database or a manipulated version.

26. The method according to claim 1, wherein objects are added or changed by directly changing said source file.

27. The method according to claim 1, wherein objects are added or changed by causing the originating program to add or change said objects, using software additions to said originating software.

28. The method according to claim 27, wherein the changes are done manually by an operator that activates said software additions.

29. The method according to claim 27, wherein the changes are done automatically by activating said software additions.

30. The method according to claim 1, wherein the target file is the same type as the source file.

31. The method according to claim 1, wherein the type of target file different than the source file.
